(19) United States
(12) Patent Application Publication
(10) Pub. No.: US 2012/0294658 A1
(43) Pub. Date: Nov. 22, 2012

(54) INTERMEDIATE TRANSFER BLANKET AND INTERMEDIATE TRANSFER BODY FOR ELECTROPHOTOGRAPHIC PRINTING

(75) Inventors: Shoichi Aoki, Tokyo (JP); Fumito Kajitani, Tokyo (JP); Koji Nishiya, Kasama-shi (JP); Sadayuki Ishikura, Kasama-shi (JP); Shinichiro Senoo, Mihara-shi (JP)

(73) Assignees: KINYOSHA CO., LTD., Tokyo (JP); MITSUBISHI HEAVY INDUSTRIES PRINTING & PACKAGING MACHINERY, LTD., Mihara-shi, Hiroshima (JP)

(21) Appl. No.: 13/576,212

(22) PCT Filed: Jan. 6, 2011
(86) PCT No.: PCT/JP2011/050097

§ 371 Date: Jul. 31, 2012

(30) Foreign Application Priority Data
Feb. 25, 2010 (JP) 2010-041006

(51) Int. Cl. G03G 15/14

(52) U.S. Cl. 399/308

(57) ABSTRACT

Each of an intermediate transfer blanket and an intermediate transfer body for electrophotographic printing uses liquid toner for transferring the liquid toner in which toner particles formed by a thermoplastic material and a pigment are distributed and mixed in a petroleum solvent in the liquid toner, and a conducting layer that is formed by urethane rubber is provided on a front surface of a blanket, thereby realizing high-quality electrophotographic printing.

### FIELD

The present invention relates to an intermediate transfer blanket used in an electrophotographic printing device that performs printing by using toner distributed to a liquid carrier, and an intermediate transfer body for electrophotographic printing to which the intermediate transfer blanket is attached.

### BACKGROUND

Conventionally, there is proposed an electrophotographic printing device that performs printing by developing a photosensitive material to produce an electrostatic latent image formed on a photosensitive body by using liquid toner in which toner containing a thermoplastic resin, a colorant and the like is distributed into a carrier, primarily transferring the electrostatic latent image on an intermediate transfer body, further transferring the liquid toner onto a surface of a printed matter, and fixing the toner contained in the transferred liquid toner onto the printed matter.

This type of electrophotographic printing device performs printing by developing a photosensitive material to produce an electrostatic latent image formed on a photosensitive body by liquid toner, primarily transferring the developed toner image onto an intermediate transfer body, and further transferring the liquid toner present on the intermediate transfer body onto a printed matter in a nip portion between the intermediate transfer body and a backup roller to which a bias voltage for transferring the developed toner image is applied.

The intermediate transfer body used in this electrophotographic printing device is configured to attach an intermediate transfer blanket to a surface of a drum, as described in Patent Literature 1, for example. The intermediate transfer blanket described in Patent Literature 1 is configured such that an adhesive layer, a fabric layer, a compressible layer, a top layer, and a conducting layer are superimposed as a blanket main body, and such that a conducting layer, a conforming layer, and a release layer are superimposed, as an image transfer unit, on a surface of the blanket main body (the conducting layer).

### CITATION LIST

### Patent Literature

Patent Literature 1: Japanese Patent Application
National Publication No. 2002-507147

### SUMMARY

### Technical Problem

In the electrophotographic printing device, the electrostatic image formed on the surface of the intermediate transfer body by toner is transferred onto a printed matter in such a manner that a current flows by a voltage applied from a rear surface of the printed matter when the printed matter contacts this intermediate transfer body. In the conventional intermediate transfer blanket described above, the conducting layer, the conforming layer (having a conductive property), and the release layer are superimposed near a front surface as the image transfer unit. In this case, because each of the layers is configured by silicon rubber, the layer is high in toner release property and excellent in the property of transferring the electrostatic image by the toner, but poor in wettability. Therefore, it is difficult to perform high-quality electronic printing.

The present invention has been achieved to solve the above problems, and an object of the present invention is to provide an intermediate transfer blanket and an intermediate transfer body for electrophotographic printing that can achieve high-quality electronic printing.

### Solution to Problem

According to an aspect of the present invention, an intermediate transfer blanket for transferring liquid toner in which toner particles formed by a thermoplastic material and a pigment are distributed and mixed in a petroleum solvent in the liquid toner, includes a conducting layer that is formed by urethane rubber and disposed on a front surface of the intermediate transfer blanket.

Therefore, by using the petroleum solvent as the solvent of the liquid toner and providing the conducting layer made of urethane rubber on the front surface of the intermediate transfer blanket, the wettability of the liquid toner on the front surface of the intermediate transfer blanket is improved. Accordingly, this can improve accuracy of transferring an image formed by the liquid toner and suppress dissolution of the intermediate transfer blanket by the liquid toner. As a result, it is possible to perform electronic printing at a high concentration and to improve the printing quality of the electronic printing.

Advantageously, in the intermediate transfer blanket, the conducting layer is provided on a front surface of a cushion layer, the conducting layer includes a first conducting layer that is arranged near a front surface of the conducting layer, and a second conducting layer that is arranged on a rear surface side of the conducting layer and a side of the cushion layer, and an electric resistance of the first conducting layer is set to be higher than an electric resistance of the second conducting layer.

Therefore, by setting the electric resistance of the first conducting layer near the front surface of the conducting layer to be higher than that of the second conducting layer, a high electric field intensity can act on the front surface of the intermediate transfer blanket, the liquid toner can move more easily, the transfer amount of the toner during printing increases, the electronic printing can be performed at a high concentration, and thus the printing quality of the electronic printing can be improved.

Advantageously, in the intermediate transfer blanket, a thickness of the first conducting layer is set to be thinner than a thickness of the second conducting layer.

Therefore, by forming the conducting layer by urethane rubber, it is possible to prevent dissolution of the conducting layer by the solvent of the toner. Furthermore, by forming the second conducting layer to be thicker than the first conducting layer, it is possible to ensure cushioning characteristics and to form an electrostatic image with high accuracy.

Advantageously, in the intermediate transfer blanket, the cushion layer is configured to superimpose a plurality of layers having different coefficients of elasticity.

Therefore, it is possible to adjust the cushion layer to have an appropriate coefficient of elasticity that is between coefficients of elasticity of a plurality of layers, to form the cushion layer having the appropriate coefficient of elasticity in proportion to toner characteristics, to prevent misalignment of the intermediate transfer blanket with respect to the base body, and to improve transfer characteristics.

Advantageously, in the intermediate transfer blanket, a toner non-permeable layer that prevents liquid toner from permeating the cushion layer from the conducting layer is provided between the cushion layer and the conducting layer.

Therefore, even if the solvent of the liquid toner permeates the conducting layer, the solvent is interrupted by the toner non-permeable layer and does not permeate the cushion layer, and the change in the coefficient of elasticity of the cushion layer and the corrosion of the base body are prevented. It is thereby possible to improve durability of the intermediate transfer blanket.

Advantageously, in the intermediate transfer blanket, the toner non-permeable layer includes a current-carrying layer provided on a front surface of the toner non-permeable layer, and is bonded to the cushion layer and the conducting layer.

Therefore, it is possible to improve the adhesion of the toner non-permeable layer.

Advantageously, in the intermediate transfer blanket, the intermediate transfer blanket is configured to superimpose the cushion layer and the conducting layer to be dividable from each other.

Therefore, by making the conducting layer dividable from the cushion layer, it is possible to replace only the conducting layer when the conducting layer is damaged, and it is possible to reduce the running cost.

According to another aspect of the present invention, an intermediate transfer body for electrophotographic printing includes: a base body; and an intermediate transfer blanket for transferring liquid toner in which toner particles formed by a thermoplastic material and a pigment are distributed and mixed in a petroleum solvent in the liquid toner. The intermediate transfer body is configured to carry charged liquid toner on a front surface of the intermediate transfer body, and is configured to transfer the charged liquid toner onto a printed matter, and a conducting layer formed by urethane rubber is provided on a front surface of the intermediate transfer blanket.

Therefore, by using the petroleum solvent as the solvent of the liquid toner and providing the conducting layer made of urethane rubber on the front surface of the intermediate transfer blanket, the wettability of the liquid toner on the front surface of the intermediate transfer blanket is improved. Accordingly, this can improve accuracy of transferring an image formed by the liquid toner and suppress dissolution of the intermediate transfer blanket by the liquid toner. As a result, it is possible to perform electronic printing at a high concentration and to improve the printing quality of the electronic printing.

Advantageously, in the intermediate transfer body for electrophotographic printing, in the intermediate transfer blanket, the conducting layer is provided on a front surface of a cushion layer, the conducting layer includes a first conducting layer that is arranged near a front surface of the conducting layer, and a second conducting layer that is arranged near a rear surface of the conducting layer and near the cushion layer, and an electric resistance of the first conducting layer is set to be higher than an electric resistance of the second conducting layer.

Therefore, by setting the electric resistance of the first conducting layer near the front surface of the conducting layer to be higher than that of the second conducting layer, a high electric field intensity can act on the front surface of the intermediate transfer blanket, the liquid toner can move more easily, the transfer amount of the toner during printing increases, the electronic printing can be performed at a high concentration, and thus the printing quality of the electronic printing can be improved.

### Advantageous Effects of Invention

According to the intermediate transfer blanket and the intermediate transfer body for electrophotographic printing of the present invention, liquid toner in which toner particles formed by a thermoplastic material and a pigment are distributed and mixed in a petroleum solvent is used, and a conducting layer formed by urethane rubber is provided on a front surface of an intermediate transfer blanket. Therefore, it is possible to perform electronic printing at a high concentration and to improve the printing quality of the electronic printing.

### BRIEF DESCRIPTION OF DRAWINGS

FIG. 1 is a cross-sectional view of relevant parts of an intermediate transfer body to which an intermediate transfer blanket according to a first embodiment of the present invention is attached.

FIG. 2 is a schematic configuration diagram of an electrophotographic printing device to which the intermediate transfer body according to the first embodiment is applied.

FIG. 3 is a schematic diagram of a developing unit in the electrophotographic printing device according to the first embodiment.

FIG. 4 is a cross-sectional view of relevant parts of an intermediate transfer body to which an intermediate transfer blanket according to a second embodiment of the present invention is attached.

### DESCRIPTION OF EMBODIMENTS

Exemplary embodiments of an intermediate transfer blanket and an intermediate transfer body for electrophotographic printing according to the present invention will be explained below in detail with reference to the accompanying drawings. The present invention is not limited to the embodiments.

### First Embodiment

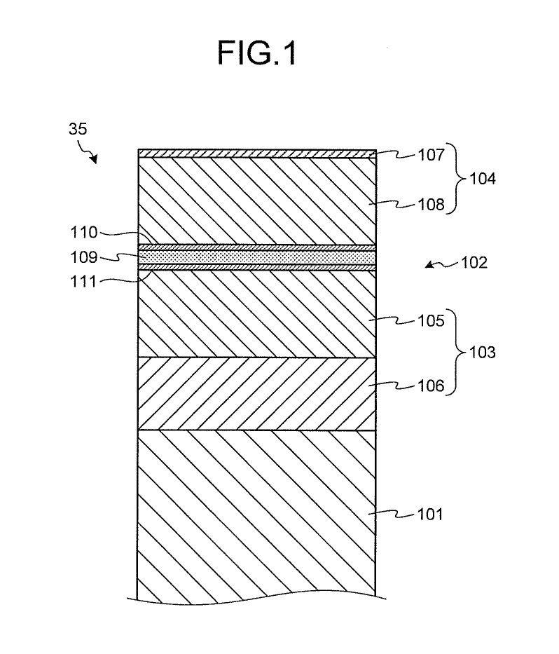

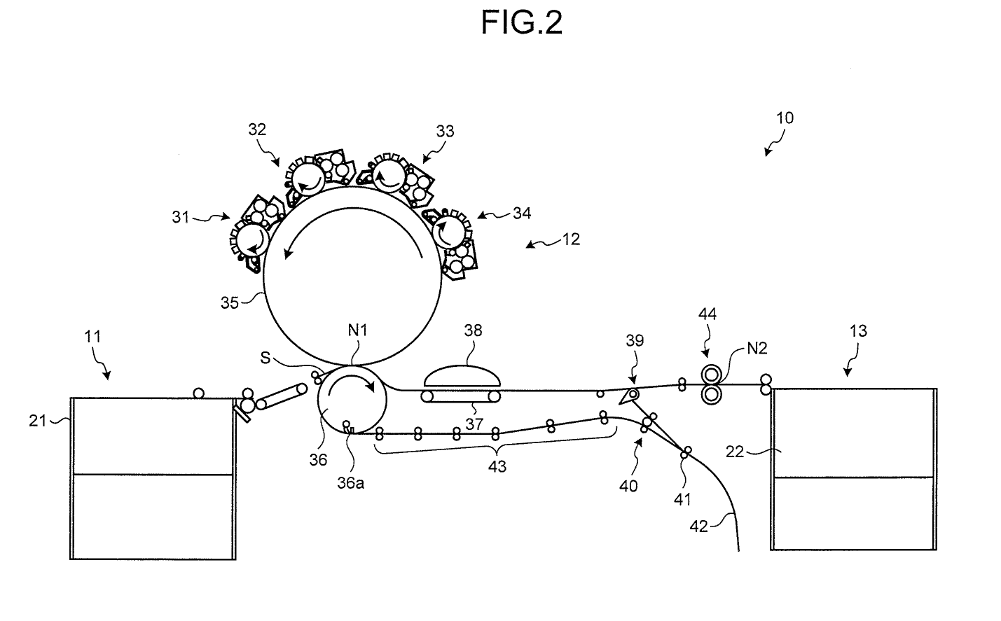

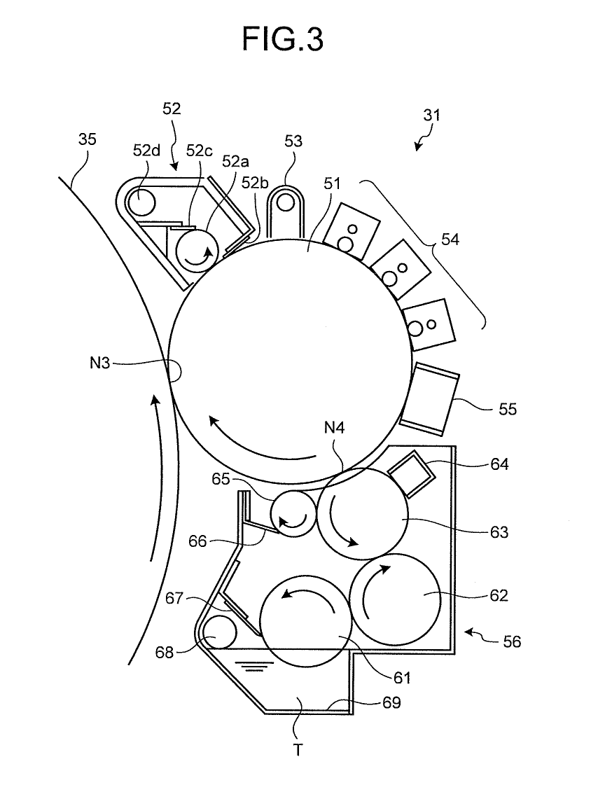

FIG. 1 is a cross-sectional view of relevant parts of an intermediate transfer body to which an intermediate transfer blanket according to a first embodiment of the present invention is attached. FIG. 2 is a schematic configuration diagram of an electrophotographic printing device to which the intermediate transfer body according to the first embodiment is applied. FIG. 3 is a schematic diagram of a developing unit in the electrophotographic printing device according to the first embodiment.

In the first embodiment, as shown in FIG. 2, an electrophotographic printing device 10, which is a liquid-development electrophotographic perfecting printer, is configured to include a feeder unit 11, a printing unit 12, and a delivery unit 13. The feeder unit 11 can supply print sheets (printed matters) S that are cut paper from a feeder tray 21 to the printing unit 12 one by one. The printing unit 12 is configured to perform printing on both sides (first and second sides) of each of these print sheets S by performing printing on one side (the first side) of each of the supplied print sheets S, and performing printing on the side (the second side) opposite to the first side. The delivery unit 13 can deliver the print sheets S on which the printing unit 12 performs both side printing to a delivery tray 22.

The electrophotographic printing device 10 according to the present embodiment is configured to be able to perform process color printing. The printing unit 12 is provided with four developing units 31, 32, 33, and 34 that correspond to process colors of K (black), C (cyan), M (magenta), and Y (yellow), respectively. The printing unit 12 is configured to include these developing units 31 to 34, an intermediate transfer body 35, a backup roller 36, a chain gripper 37, a flashlight irradiation device 38 that serves as a toner fixing device, a switch mechanism 39, a reciprocating guide roller 40 that constitutes a reversing device, a switchback roller 41, a sheet storage unit 42, a plurality of transport rollers 43, and a pair of heating rollers 44.

The intermediate transfer body 35 and the backup roller 36 contact each other and a nip portion (a transfer position) N1 is formed in a contact portion. A circumferential surface of the intermediate transfer body 35 is configured by, for example, urethane-based conductive rubber as described later, and a bias voltage such as about −200 to −300 volts is applied to the intermediate transfer body 35.

Meanwhile, the backup roller 36 is arranged to apply a predetermined pressure—for example, about 1 to 13 kg/cm to the intermediate transfer body 35, and forms the nip portion N1 described above. Accordingly, a predetermined nip pressure is applied to each print sheet S by being transported between the intermediate transfer body 35 and the backup roller 36. For example, a transfer bias of about −800 volts is applied to the backup roller 36. Accordingly, a difference between the bias voltage (−200 to −300 volts) of the intermediate transfer body 35 and the bias voltage (about −800 volts) of the backup roller 36 produces a force for bringing liquid toner T (described later) to the backup roller 36, and accelerates electrostatic transfer of the liquid toner T from the intermediate transfer body 35 to the print sheet S.

In the nip portion N1, an image is transferred from the intermediate transfer body 35 onto the print sheet S by the liquid toner T. In this case, a gripper 36a that grips and releases the print sheet S transported onto a circumferential surface of the backup roller 36 by the transport rollers 43 and that thereby introduces the print sheet S to the nip portion N1 again is provided on the backup roller 36.

The chain gripper 37 is configured to arrange two endless chains side by side in parallel, and a plurality of grippers are attached to each of the chains equidistantly. An interval of the grippers is set to be shorter than a length of each of the print sheets S in a sheet transport direction. The grippers are configured to grip side edge portions of the print sheet S, to grip the print sheet S at a predetermined transport position by a grip-release mechanism, and to release gripping of the print sheet S at another predetermined position.

The flashlight irradiation device 38 that serves as a toner fixing device is arranged upward of a transport route on which the chain gripper 37 transports the print sheets S. The flashlight irradiation device 38 is configured by a xenon flash lamp, a metal halide lamp, a krypton lamp, a xenon-mercury lamp or the like, and can heat the print sheets S in response to a signal from a control device.

The flashlight irradiation device 38 instantaneously irradiates a flash light to an upper side (a print surface) of each print sheet S at a timing at which the print sheet S passes through a lower portion of the flashlight irradiation device 38 by the chain gripper 37. The flashlight irradiation device 38 can thereby heat the print sheet S without contacting the print sheet S.

The switch mechanism 39 includes a guide portion (a protrusion) for guiding each print sheet S in the transport direction, and is rotatably supported. The control device can switch over a position of this guide portion. The reciprocating guide roller 40 includes three rollers. The print sheet S transported from the switch mechanism 39 to the reciprocating guide roller 40 is, therefore, transported to the switchback roller 41 by driving the two upper rollers to rotate. On the other hand, the print sheet S transported from the switch mechanism 39 to the reciprocating guide roller 40 is transported to the transport rollers 43 by driving the two lower rollers to rotate.

The switchback roller 41 is configured to be able to grip and transport each print sheet S by a pair of driving rollers. The switchback roller 41 temporarily stores the print sheet S in the sheet storage unit 42 by as much as a preset necessary length L of the print sheet S while holding the print sheet S transported from the reciprocating guide roller 40. Thereafter, the switchback roller 41 is driven to rotate in an opposite direction while holding the print sheet S, transports the held print sheet S from the sheet storage unit 42 in the opposite direction, and transports the print sheet S to the reciprocating guide roller 40.

The print sheet S transported from the switchback roller 41 to the reciprocating guide roller 40 is introduced toward the transport rollers 43. The transport rollers 43 transport the print sheet S to the backup roller 36. The gripper 36a of the backup roller 36 transports the print sheet S to a portion right before the nip portion N1 in response to rotation of the backup roller 36 while gripping the print sheet S, releases gripping of the print sheet S, and is then stored within the backup roller 36.

At this time, the print sheet S is already reversed from when the print sheet S passes through the nip portion N1 first time. Therefore, in the nip portion N1, the intermediate transfer body 35 contacts the second side that is the opposite side to the first side of the print sheet S. That is, the electrophotographic printing device 10 is configured such that the intermediate transfer body 35 and the backup roller 36 function to both transfer the liquid toner T onto the first side of the print sheet S and transfer the liquid toner T onto the second side of the print sheet S. The electrophotographic printing device 10 is configured such that the flashlight irradiation device 38 functions to both irradiate a flash light to the first side of the print sheet S and to irradiate a flash light to the second side thereof.

The paired heating rollers 44 are arranged closer to the delivery unit 13 than the switch mechanism 39. The surface temperature of the heating rollers 44 is set to be an appropriate temperature, and the nip portion N2 in which the paired rollers 44 pressurize the print sheet S when the print sheet S passes through the nip portion N2 is formed.

In the printing unit 12 described above, the developing units 31 to 34 are arranged around the intermediate transfer body 35 side by side in a rotational direction of the intermediate transfer body 35, and substantially identical in configuration. The developing unit 31 is described next in detail.

As shown in FIG. 3, the developing unit 31 is configured to form an electrostatic latent image on a photosensitive drum 51 based on image data transmitted from a control device (not shown), and to transfer the liquid toner T from the photosensitive drum 51 onto the intermediate transfer body 35 at a position corresponding to the electrostatic latent image so as to transfer the liquid toner T onto the circumferential surface of the intermediate transfer body 35.

The liquid toner T is obtained by distributing and mixing toner particles formed by a thermoplastic material and a pigment (colorant or dye) into a carrier. In this case, the toner in which the toner particles having an average particle diameter of about 1 to 2 micrometers and contained, by about 20 to 40% by weight, in a petroleum solvent (mineral oil, for example, that is a nonpolar paraffin-based solvent) serving as the carrier is used as the liquid toner T.

The developing unit 31 is configured to include the photosensitive drum (a photosensitive body) 51, a cleaning unit 52, a static eliminator 53, a photosensitive-body charging device 54, an exposure device 55, and a developing device 56. A photosensitive layer formed to contain amorphous silicon (a-Si) and a photosensitizing agent such as photosensitive polymer is formed on a circumferential surface of the photosensitive drum 51. The photosensitive drum 51 contacts the intermediate transfer body 35 in a nip portion N3, and is configured to be able to transfer the liquid toner T on the photosensitive drum 51 onto the intermediate transfer body 35.

The cleaning unit 52, the static eliminator 53, the photosensitive-body charging device 54, the exposure device 55, and the developing device 56 are arranged around the photosensitive body 51 in this order with the nip portion N3 set as a starting point to face the photosensitive layer along the rotational direction of the photosensitive drum 51. The cleaning unit 52 is configured to include a cleaning roller 52a, blades 52b and 52c, and a liquid-toner discharge port 52d. The cleaning unit 52 can remove the liquid toner T remaining on the circumferential surface of the photosensitive drum 51 and discharge the liquid toner T to a toner collection path (not shown).

That is, the cleaning roller 52a can collect the liquid toner T remaining on the circumferential surface of the photosensitive drum 51 by rotating in a driven direction while being in contact with the photosensitive drum 51. The blade 52b is a rectangular plate formed by an elastic material, and is arranged so that one of longer sides of the blade 52b contacts the circumferential surface of the photosensitive drum 51. The blade 52b can scratch off the liquid toner T present on the circumferential surface of the photosensitive drum 51 that the cleaning roller 52a is unable to remove, and completely can remove the liquid toner T from the photosensitive drum 51.

The blade 52c is a rectangular plate formed by an elastic material, and is arranged so that one of longer sides of the blade 52c contacts a circumferential surface of the cleaning roller 52a. The blade 52c can scrape off and remove the liquid toner T adhering to the circumferential surface of the cleaning roller 52a. The liquid toner T removed from the photosensitive drum 51 is discharged from the liquid-toner discharge port 52d.

The static eliminator 53 functions to eliminate electric charge that remains on the photosensitive layer of the photosensitive drum 51. The photosensitive-drum charging device 54 is configured to arrange a plurality of (three in the present embodiment) noncontact discharge chargers such as corotron or scorotron chargers along a circumferential direction of the photosensitive drum 51. The photosensitive-drum charging device 54 functions to electrify the photosensitive layer of the photosensitive drum 51 uniformly with about 500 volts, for example.

The exposure device 55 is configured by a light emitting device (an LED array) having luminous bodies (LEDs in the present embodiment) arranged into a rod shape along an axial direction of the photosensitive drum 51. The exposure device 55 causes the respective LEDs to emit light based on the image data transmitted from a control device. That is, the exposure device 55 irradiates the light onto a surface of the photosensitive layer of the photosensitive drum 51 electrified uniformly by the photosensitive-body charging device 54. Accordingly, electrification of the photosensitive layer is eliminated in a light irradiated portion, and the electrostatic latent image based on the image can be formed on the photosensitive layer. The light emitting device can be configured to scan a semiconductor laser or the like based on the image data and to form the electrostatic latent image in place of using the LED array.

The developing device 56 is configured to include an anilox roller 61, a distributing roller 62, a developing roller 63, a toner charger 64, a cleaning roller 65, blades 66 and 67, a toner supply port 68, and a liquid-toner storage unit 69. The developing device 56 transfers the liquid toner T to the portion of the photosensitive drum 51 in which the electrostatic latent image is formed.

The liquid toner T described above is stored in the toner storage unit 69, and the liquid toner T is appropriately supplied from the toner supply port 68 to the anilox roller 61 so as to partially soak the anilox roller 61 in the liquid toner T. The anilox roller 61 is a metal roller, and a concave portion (a cell) suited to supply the liquid toner T by a desired film thickness is formed on an entire circumferential surface of the anilox roller 61. The anilox roller 61 can be driven to rotate in the same direction as that of the photosensitive drum 51.

Furthermore, the blade 67 is formed by a high-density polyethylene plate. A tip end of the blade 67 contacts a circumferential surface of the anilox roller 61, whereby the blade 67 can scrape off the liquid toner T adhering to the circumferential surface of the anilox roller 61 and the liquid toner T at a desired film thickness can be formed on the circumferential surface of the anilox roller 61. The distributing roller 62 is formed by urethane rubber, is arranged between the anilox roller 61 and the developing roller 63, and comes in contact with the anilox roller 61 and the developing roller 63. The distributing roller 62 can rotate in a direction such that a circumferential surface of the distributing roller 62 moves in the same direction as that of the anilox roller 61 at a point of contact at which the distributing roller 62 contacts the anilox roller 61.

The developing roller 63 is formed by conductive rubber, and is arranged to form a nip portion N4 by contacting the photosensitive drum 51. The developing roller 63 can rotate in a direction such that a circumferential surface of the developing roller 63 moves in the same direction as that of the photosensitive drum 51 in the nip portion N4. Furthermore, a velocity of the circumferential surface of the developing roller 63 is set to the same velocity as that of the photosensitive drum 51. In this way, the developing roller 63 having a conductive property contacts the photosensitive drum 51 in the nip portion N4, thereby performing development by transferring the liquid toner T from the circumferential surface of the developing roller 63 onto the portion of the photosensitive drum 51 in which the electrostatic latent image is formed.

The developed liquid toner T present on the circumferential surface of the photosensitive drum 51 is transferred onto the intermediate transfer body 35 in the nip portion N3, and a liquid toner layer including an image by the toner can be formed on the circumferential surface of the intermediate transfer body 35.

While only the developing unit 31 has been described, the developing units 32, 33, and 34 are identical in configuration to the developing unit 31. The developing units 31 to 34 are arranged so that toner images formed by the respective developing units 31 to 34 can be superimposed on the circumferential surface of the intermediate transfer body 35 at the same position, and that the toner images can be transferred from the intermediate transfer body 35 onto an appropriate position on the print sheet S synchronously with a timing at which the print sheet S passes through the nip portion N1.

The toner charger 64 is proximate to the circumferential surface of the developing roller 63, and arranged to be located upstream of the nip portion N4 in a rotational direction of the developing roller 63 and downstream of a contact surface on which the developing roller 63 contacts the distributing roller 62 in the rotational direction of the developing roller 63. The toner charger 64 is a noncontact discharge charger such as a corotron or scorotron charger, and functions to equalize distribution of charged toner contained in the liquid toner T adhering to the circumferential surface of the developing roller 63 in the carrier.

The cleaning roller 65 contacts the developing roller 63 downstream of the nip portion N4 in the rotational direction of the developing roller 63, and can remove the liquid toner T remaining on the circumferential surface of the developing roller 63 without transferring the liquid toner T onto the photosensitive drum 51. The blade 66 can scrape off the liquid toner T adhering to a circumferential surface of the cleaning roller 65.

In the electrophotographic printing device 10 according to the first embodiment configured as described above, when only one print sheet S is fed from the feeder unit 21 to the printing unit 12, the developing units 31 to 34 transfer the liquid toner T corresponding to the respective colors of K (black), C (cyan), M (magenta), and Y (yellow) onto the photosensitive drum 51 on which an electrostatic image to be transferred onto the first side of the print sheet S is formed, and develop the image on the photosensitive drum 51, as shown in FIGS. 2 and 3. The liquid toner T transferred onto the circumferential surface of the photosensitive drum 51 is transferred onto the intermediate transfer body 35, and transferred onto the side (the first side) on which the print sheet S contacts the intermediate transfer body 35 from the circumferential surface of the intermediate transfer body 35.

The print sheet S onto the first side of which the liquid toner T is transferred is transported in a state where the chain gripper 37 grips both ends of the print sheet S, and irradiated with the flash light from the flashlight irradiation device 38, and the first side of the print sheet S is heated. The toner contained in the liquid toner T transferred onto the first side of the print sheet S is thereby molten, and the liquid toner T is fixed onto the first side of the print sheet S by evaporation of the carrier.

The print sheet S onto the first side of which the liquid toner T is fixed is guided by the switch mechanism 39, and temporarily stored in the sheet storage unit 42 in a state where the switchback roller 41 holds the print sheet S. After being stored in the sheet storage unit 42 by the switchback roller 41, the print sheet S is transported again to the reciprocating guide roller 40 and guided to the transport rollers 43 by the reciprocating guide roller 40.

The print sheet S transported by the transport rollers 43 is transported to the gripper 36a of the backup roller 36, and the gripper 36a grips a tip end of the print sheet S in a transport direction. On the other hand, in the printing unit 12, the developing units 31 to 34 transfer the liquid toner T of the corresponding colors of K (black), C (cyan), M (magenta), and Y (yellow) onto the circumferential surface of the photosensitive drum 51 on which the electrostatic image to be transferred onto the second side of the print sheet S is to be formed, and develop the image on the photosensitive drum 51.

The photosensitive drum 51 transfers the liquid toner T transferred onto the circumferential surface thereof onto the intermediate transfer body 35, and the liquid toner T is transferred from the circumferential surface of the intermediate transfer body 35 onto the side (the second side) on which the print sheet S contacts the intermediate transfer body 35. The print sheet S in a state where the chain gripper 37 grips the both ends of the print sheet S is irradiated with the flash light from the flashlight irradiation device 38, and the second side of the print sheet S is heated. The toner contained in the liquid toner T on the second side of the print sheet S is sufficiently molten, and the carrier is evaporated, thereby fixing the liquid toner T present on the second side of the print sheet S onto the second side thereof.

The print sheet S on the second side of which the liquid toner T has been fixed is transported to the nip portion N2 of the paired heating rollers 44 through the switch mechanism 39, and both sides of the print sheet S are pressurized. Thereafter, the print sheet S the both sides, that is, the first and second sides of which have been heated is cooled while being transported to the delivery unit 13, and delivered to the delivery tray 22, thus finishing printing.

In the electrophotographic printing device 10 configured as described above, the intermediate transfer body 35 is configured to include a base body 101 rotatably supported by a frame (not shown) and a blanket (an intermediate transfer blanket) 102 attached to an outer circumferential portion of the base body 101, as shown in FIG. 1. In this case, a gripper bite (not shown) is provided on the outer circumferential portion of the base body 101, and the band-like blanket 102 is attached to the outer circumferential portion of the base body 101 and one end and the other end of the blanket 102 are fixed to the gripper bite, thereby attaching the blanket 102 to the base body 101.

The blanket 102 is configured to include a conducting layer 104 provided on a front surface of a cushion layer 103. The conducting layer 104 can carry the charged liquid toner T on a front surface thereof, and the liquid toner T can be transferred onto the print sheet S. The blanket 102 is described next in detail.

The cushion layer 103 is configured to superimpose a first cushion layer 105 and a second cushion layer 106 as a plurality of (two in the present embodiment) layers having different coefficients of elasticity. The cushion layer 103 has appropriate hardness and softness because of the need to ensure predetermined pressures (nip pressures) in the nip portions N1 and N3 (see FIGS. 2 and 3), respectively, and has appropriate adhesion because of the need to ensure adhesion to the base body 101. The cushion layers 105 and 106 are formed by a sponge produced by a foam-molding synthetic resin such as polyurethane, and differ in the coefficient of elasticity because of the difference in the expansion ratio. Furthermore, because the cushion layers 105 and 106 are formed by a sponge, it is possible to set a high friction coefficient against a front surface of the base body 101 and to ensure appropriate adhesion.

In this case, the cushion layer 103 is configured to superimpose the first cushion layer 105 having a high coefficient of elasticity on the second cushion layer 106 having a lower coefficient of elasticity than that of the first cushion layer 105. Therefore, the cushion layer 103 has an appropriate coefficient of elasticity that is intermediate between the two coefficients of elasticity, and the coefficient of elasticity of the cushion layer 103 is adjusted to an appropriate coefficient of elasticity for characteristics of the liquid toner T. Therefore, the cushion layer 103 is attached to the front surface of the base body 101 with the high friction coefficient, whereby the cushion layer 103 is not misaligned during printing and is adjusted to have the appropriate coefficient of elasticity. Therefore, it is possible to transfer the electrostatic image onto the print sheet S without any misalignment.

That is, it is preferable to adjust the cushion layer 103 to have a low coefficient of elasticity when the liquid toner T contains soft toner particles, and to adjust the cushion layer 103 to have a high coefficient of elasticity when the liquid toner T has a high solvent viscosity. In this manner, the cushion layer 103 is adjusted to have the coefficient of elasticity in proportion to the characteristics of the liquid toner T, and it is possible to transfer a sharpened electrostatic image onto the print sheet S while preventing deformation of halftone dots.

As described above, the liquid toner to be used is formed by distributing and mixing toner particles formed by a thermoplastic material and a pigment in the petroleum solvent. The conducting layer 104 that transfers the liquid toner is formed by urethane rubber having a high affinity to the liquid toner.

That is, the conducting layer 104 includes a first conducting layer 107 that is arranged near a front surface of the conducting layer 104 and a second conducting layer 108 that is arranged near a rear surface of the conducting layer 104 and near the cushion layer 103. An electric resistance of the first conducting layer 107 is set to be higher than that of the second conducting layer 108. In this case, each of the conducting layers 107 and 108 is formed by urethane rubber and the thickness of the first conducting layer 107 is set to be thinner than that of the second conducting layer 108. Each of the conducting layers 107 and 108 that constitute the conducting layer 104 is formed by polyester isocyanate or polyether isocyanate, for example. Accordingly, the conducting layer 104 has higher wettability than that of fluorine-based rubber, and is less repellent to the liquid toner, so that it is possible to form a highly accurate image. Furthermore, the conducting layer 104 is polar because of a molecular structure thereof whereas the solvent of the liquid toner is petroleum based (such as mineral oil). Therefore, the compatibility of the conducting layer 104 to the liquid toner is low. That is, the conducting layer 104 is less dissoluble to the liquid toner T using the mineral oil because a solubility parameter SP of the conducting layer 104 is about 7.0.

For example, by setting the first conducting layer 107 to have a carbon content of 0.5 wt % and a thickness of 50 micrometers, a volume resistance of the first conducting layer 107 is set to 10⁻¹² Ωcm. Furthermore, for example, by setting the second conducting layer 108 to have a carbon content of 3.0 wt % and a thickness of 400 micrometers, a volume resistance of the second conducting layer 108 is set to 10⁻⁵ Ωcm.

When a predetermined pressure is applied to the blanket 102, an electric field intensity E is high because the first conducting layer 107 arranged near the front surface of the conducting layer 104 is high in volume resistance and is thin. On the other hand, the second conducting layer 108 arranged near the rear surface of the conducting layer 104 is thick, but considerably low in volume resistance, so that a current easily flows to the second conducting layer 108 and the second conducting layer 108 can be regarded as a kind of metal (a conductor). An effective thickness of the conducting layer 104 on which an electric field acts can be regarded only as the thickness of the first conducting layer 107.

The electric field intensity E can be obtained as expressed by the following expression based on a voltage V and an effective thickness d.

E=V/d

Because the first conducting layer 107 is high in volume resistance and thin, the conducting layer 104 can ensure the high electric field intensity E, the liquid toner T can be easily moved, a transfer amount of the liquid toner T during printing increases, and the electronic printing can be performed at high concentration. Furthermore, because the second conducting layer 108 is thick although the first conducting layer 107 is thin, the conducting layer 104 can ensure a predetermined elastic force (predetermined cushioning characteristics), which can suppress disturbance of the image during the transfer of the liquid toner T.

In the above explanations, the volume resistance of the first conducting layer 107 is set to 10⁻¹² Ωcm by setting the carbon content to 0.5 wt % and the thickness to 50 micrometers. However, the volume resistance of the first conducting layer 107 is not limited to this numerical value. The electric field intensity E that acts on the first conducting layer 107 is preferably 10 to 200 V/μm, in which case, it is preferable that the voltage V is 500 to 2000 volts and that the thickness d is 10 to 50 micrometers.

Furthermore, in the blanket 102, a toner non-permeable layer 109 that prevents the liquid toner T from permeating the cushion layer 103 from the conducting layer 104 is provided between the cushion layer 103 and the conducting layer 104. The toner non-permeable layer 109 is obtained by performing an aluminum vapor deposition treatment on a surface of an A-PET (amorphous polyethylene terephthalate) to form a current-carrying layer. In this case, a copper plated layer can be used as the current-carrying layer.

The toner non-permeable layer 109 is bonded onto the rear surface of the conducting layer 104 and the front surface of the cushion layer 103 by adhesive materials 110 and 111, respectively. In this case, a double-faced tape or a laminator can be also used as these adhesive materials.

Therefore, even if the solvent permeates the conducting layer 104 when the liquid toner T is transferred onto the surface of the blanket 102, the solvent is interrupted by the toner non-permeable layer 109 and does not permeate the cushion layer 103, and a change in the coefficient of elasticity of the cushion layer 103 and corrosion of the base body 101 are prevented.

As described above, in the intermediate transfer blanket according to the first embodiment, the conducting layer 104 that is used to transfer the liquid toner in which the toner particles formed by a thermoplastic material and the pigment are distributed and mixed in the petroleum solvent, and the conducting layer 104 that is formed by urethane rubber is provided on the front surface of the blanket 102.

Therefore, by using the petroleum solvent as the solvent of the liquid toner and providing the conducting layer 104 made of urethane rubber on the front surface of the blanket 102, the wettability of the liquid toner on the front surface of the blanket 102 is improved. Accordingly, this can improve accuracy of transferring the image formed by the liquid toner and suppress dissolution of the blanket 102 by the liquid toner. As a result, it is possible to perform electronic printing at the high concentration and to improve a printing quality of the electronic printing.

In the intermediate transfer blanket according to the first embodiment, the blanket 102 is configured by providing the conducting layer 104 on the front surface of the cushion layer 103, the first conducting layer 107 that is arranged near the front surface of the conducting layer 104 and the second conducting layer 108 that is arranged near the rear surface of the conducting layer 104 and near the cushion layer 103 are provided as the conducting layer 104, and the electric resistance of the first conducting layer 107 is set to be higher than that of the second conducting layer 108.

Therefore, by setting the electric resistance of the first conducting layer 107 near the front surface of the conducting layer 104 to be higher than that of the second conducting layer 108, the high electric field intensity can act on the front surface of the blanket 102, the liquid toner T can move more easily, the transfer amount of the liquid toner T during printing increases, the electronic printing can be performed at the high concentration, and the printing quality of the electronic printing can be improved.

In the intermediate transfer blanket according to the first embodiment, the conducting layer 104 is formed by urethane rubber, and the thickness of the first conducting layer 107 is set to be thinner than that of the second conducting layer 108. Therefore, by forming the conducting layer 104 by urethane rubber, it is possible to prevent the dissolution of the conducting layer 104 by the solvent of the liquid toner T. In addition, by forming the second conducting layer 108 to be thicker than the first conducting layer 107, it is possible to ensure the cushioning characteristics and to form the electrostatic image with high accuracy.

In the intermediate transfer blanket according to the first embodiment, the cushion layer 103 is configured to superimpose the first cushion layer 105 and the second cushion layer 106 having the different coefficients of elasticity. Therefore, it is possible to adjust the cushion layer 103 to have the appropriate coefficient of elasticity that is between the coefficients of elasticity of the respective cushion layers 105 and 106, to form the cushion layer 103 having the appropriate coefficient of elasticity in proportion to the characteristics of the liquid toner T, to prevent misalignment of the blanket 102 with respect to the base body 101, and to improve transfer characteristics.

In the intermediate transfer blanket according to the first embodiment, the toner non-permeable layer 109 that prevents the liquid toner T from permeating the cushion layer 103 from the conducting layer 104 is provided between the cushion layer 103 and the conducting layer 104. Therefore, even if the solvent of the liquid toner T permeates the conducting layer 104, the solvent is interrupted by the toner non-permeable layer 109 and does not permeate the cushion layer 103, and the change in the coefficient of elasticity of the cushion layer 103 and the corrosion of the base body 101 are prevented. It is thereby possible to improve durability of the intermediate transfer blanket.

In this case, the toner non-permeable layer 109 has the current-carrying layer provided on the front surface thereof, and is bonded to the cushion layer 103 and the conducting layer 104. Therefore, it is possible to improve the adhesion of the toner non-permeable layer 109.

### Second Embodiment

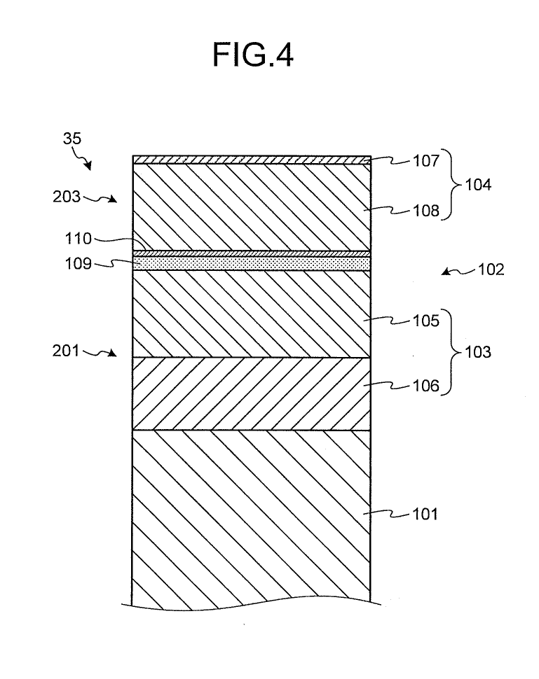

FIG. 4 is a cross-sectional view of relevant parts of an intermediate transfer body to which an intermediate transfer blanket according to a second embodiment of the present invention is attached. Elements having functions identical to those described in the above embodiment are denoted by like reference signs and redundant explanations thereof will be omitted.

In the second embodiment, similarly to the first embodiment, the intermediate transfer body 35 is configured to include the base body 101 and the blanket 102 that is attached to the outer circumferential portion of the base body 101, configured such that the blanket 102 is configured to provide the conducting layer 104 on the front surface of the cushion layer 103, and that the toner non-permeable layer 109 is provided between the cushion layer 103 and the conducting layer 104.

In the second embodiment, the blanket 102 is configured to be divided into a first blanket 201 near the base body 101 and a second blanket 203 near the front surface of the intermediate transfer body 35. That is, the first blanket 201 is configured by the cushion layer 103 (the first cushion layer 105 and the second cushion layer 106). The second blanket 203 is configured by the conducting layer 104 (the first conducting layer 107 and the second conducting layer 108) and the toner non-permeable layer 109.

In this case, the first blanket 201 (the cushion layer 103) is formed to have a predetermined thickness by cutting a cushion material to have a predetermined size, winding the cushion material around a rotary cylinder (not shown), and polishing a surface of this cushion material. The cushion layer 103 formed as described above is attached to the front surface of the base body 101 and fixed to the cylinder while causing the gripper bite to grip the ends of the cushion layer 103.

The second blanket 203 (the conducting layer 104 and the toner non-permeable layer 109) is formed as follows. An undiluted solution of rubber adhesive is coated on a glass press platen that serves as a base plate to form a rubber film having a predetermined thickness. The rubber film is burned at a predetermined temperature for a predetermined time to harden rubber, thereby forming the second conducting layer 108. The first conducting layer 107 is formed on the front surface of the second conducting layer 108 by spray coating. Thereafter, the toner non-permeable layer 109 is bonded to the rear surface of the conducting layer 104.

The second blanket 203 (the conducting layer 104 and the toner non-permeable layer 109) is attached to the front surface of the first blanket 201 (the cushion layer 103) and fixed to the cylinder by causing the gripper bite to grip ends of the second blanket 203.

As described above, the intermediate transfer blanket according to the second embodiment is configured to superimpose the first blanket 201 configured by the cushion layer 103 and the second blanket 203 configured by the conducting layer 104 and the toner non-permeable layer 109 to be dividable from each other.

Therefore, by making the second blanket 203 dividable from the first blanket 201, it is possible to replace only the conducting layer 104 when the conducting layer 104 has reached the end of its life because of damage or the like, and it is possible to reduce the running cost.

While the above embodiments have explained the intermediate transfer body 35 as a drum-type, the intermediate transfer body 35 can be of a belt-type, and in this case, it suffices that a blanket is attached on a surface of a belt-type base body.

### INDUSTRIAL APPLICABILITY

The intermediate transfer blanket and the intermediate transfer body for electrophotographic printing according to the present invention realize high-quality electronic printing by providing a conducting layer formed by urethane rubber on a front surface of the intermediate transfer blanket by the use of a petroleum solvent for liquid toner, and the intermediate transfer blanket and the intermediate transfer body for electrophotographic printing can be applied to any type of electrophotographic printing devices.

### REFERENCE SIGNS LIST

10 electrophotographic printing device
11 feeder unit
12 printing unit
13 delivery unit
31, 32, 33, 34 developing unit
35 intermediate transfer body (intermediate transfer body for electrophotographic printing)
36 backup roller
38 flashlight irradiation device (toner fixing device)
101 base body
102 blanket (intermediate transfer blanket)
103 cushion layer
104 conducting layer
105 first cushion layer
106 second cushion layer
107 first conducting layer
108 second conducting layer
109 toner non-permeable layer
110, 111 adhesive material
201 first blanket
203 second blanket

1. An intermediate transfer blanket for transferring liquid toner in which toner particles formed by a thermoplastic material and a pigment are distributed and mixed in a petroleum solvent in the liquid toner, comprising
a conducting layer that is formed by urethane rubber and disposed on a front surface of the intermediate transfer blanket.

2. The intermediate transfer blanket according to claim 1, wherein the conducting layer is provided on a front surface of a cushion layer, the conducting layer includes a first conducting layer that is arranged near a front surface of the conducting layer, and a second conducting layer that is arranged on a rear surface side of the conducting layer and a side of the cushion layer, and an electric resistance of the first conducting layer is set to be higher than an electric resistance of the second conducting layer.

3. The intermediate transfer blanket according to claim 2, wherein a thickness of the first conducting layer is set to be thinner than a thickness of the second conducting layer.

4. The intermediate transfer blanket according to claim 1, wherein the cushion layer is configured to superimpose a plurality of layers having different coefficients of elasticity.

5. (canceled)

6. (canceled)

7. The intermediate transfer blanket according to claim 1, wherein the intermediate transfer blanket is configured to superimpose the cushion layer and the conducting layer to be dividable from each other.

8. An intermediate transfer body for electrophotographic printing, the intermediate transfer body comprising:
a base body; and
an intermediate transfer blanket for transferring liquid toner in which toner particles formed by a thermoplastic material and a pigment are distributed and mixed in a petroleum solvent in the liquid toner, wherein
the intermediate transfer body is configured to carry charged liquid toner on a front surface of the intermediate transfer body, and is configured to transfer the charged liquid toner onto a printed matter, and
a conducting layer formed by urethane rubber is provided on a front surface of the intermediate transfer blanket.

9. The intermediate transfer body for electrophotographic printing according to claim 8, wherein in the intermediate transfer blanket, the conducting layer is provided on a front surface of a cushion layer, the conducting layer includes a first conducting layer that is arranged near a front surface of the conducting layer, and a second conducting layer that is arranged near a rear surface of the conducting layer and near the cushion layer, and an electric resistance of the first conducting layer is set to be higher than an electric resistance of the second conducting layer.
